(19) United States
(12) Patent Application Publication
(10) Pub. No.: US 2026/0149675 A1
(43) Pub. Date: May 28, 2026

(54) PROCESSING METHOD AND DEVICE AND ELECTRONIC DEVICE

(71) Applicant: Lenovo (Beijing) Limited, Beijing (CN)

(72) Inventor: Yonghua HU, Beijing (CN)

(21) Appl. No.: 19/398,480

(22) Filed: Nov. 24, 2025

(30) Foreign Application Priority Data
Nov. 27, 2024 (CN) 202411719358.X

(51) Int. Cl. H04L 51/02; H04L 51/04

(52) U.S. Cl. CPC H04L 51/02; H04L 51/04

(57) ABSTRACT

A processing method, applied to a first electronic device, including, in response to receiving communication information sent by a second electronic device, if the first electronic device is in a first state, obtaining sensor data of the first electronic device; determining first state information representing a current user behavior state based on the sensor data; generating target reply information including the first state information; and sending the target reply information to the second electronic device, the first state indicating that the first electronic device has not responded to the communication information.

### CROSS-REFERENCES TO RELATED APPLICATION

This application claims priority to Chinese Patent Application No. 202411719358.X filed on Nov. 27, 2024, the entire content of which is incorporated herein by reference.

### FIELD OF TECHNOLOGY

The present disclosure relates to the field of artificial intelligence technology and, more specifically, to a processing method and device, and an electronic device.

### BACKGROUND

In systems for instant calls, emails, social media messages, chat apps, or customer services, an auto-reply with preset messages can be set up when the user is unable to respond immediately. This auto-reply feature can help manage user expectations, notifying the recipient that the message has been received and that a specific response may be expected at a later time.

However, current auto-reply methods use fixed template messages and cannot provide personalized replies based on different scenarios.

### SUMMARY

One aspect of this disclosure provides a processing method. The processing method is applied to a first electronic device. The method includes in response to receiving communication information sent by a second electronic device, if the first electronic device is in a first state, obtaining sensor data of the first electronic device; determining first state information representing a current user behavior state based on the sensor data; generating target reply information including the first state information; and sending the target reply information to the second electronic device. The first state indicates that the first electronic device has not responded to the communication information.

Another aspect of this disclosure provides a processing device that is applied to a first electronic device. The processing device includes an acquisition module, a determination module, a generation module and a sending module. The acquisition module is configured to, in response to receiving communication information sent by a second electronic device, obtaining sensor data of the first electronic device if the first electronic device is in a first state. The determination module is configured to determine first state information representing a current user behavior state based on the sensor data. The generation module is configured to generate target reply information including the first state information. The sending module is configured to send the target reply information to the second electronic device. The first state indicates that the first electronic device has not responded to the communication information.

Another aspect of this disclosure provides a first electronic device. The first electronic device includes one or more sensors and one or more processors. The one or more sensors are configured to obtain sensor data based on a state of the first electronic device. The one or more processors are configured to, in response to receiving communication information sent by a second electronic device, determine first state information representing a current user behavior state based on the sensor data, generate target reply information including the first state information, and send the target reply information to the second electronic device.

### BRIEF DESCRIPTION OF THE DRAWINGS

FIG. 1 is an example application scenario of a processing method according to some embodiments of the present disclosure.

FIG. 2 is a flowchart of the processing method according to some embodiments of the present disclosure.

FIG. 3 is a flowchart of a method of generating target reply information according to some embodiments of the present disclosure.

FIG. 4 is a flowchart of a method of determining first state information according to some embodiments of the present disclosure.

FIG. 5 is a flowchart of the method of determining the first state information according to some embodiments of the present disclosure.

FIG. 6A is a flowchart of the method of generating the target reply information according to some embodiments of the present disclosure.

FIG. 6B is a logic flowchart of the processing method according to some embodiments of the present disclosure.

FIG. 7 is a flowchart of a method of responding to received communication information according to some embodiments of the present disclosure.

FIG. 8 is a flowchart of the processing method according to some embodiments of the present disclosure.

FIG. 9 is a schematic structural diagram of a processing device according to some embodiments of the present disclosure.

FIG. 10 is a block diagram of a first electronic device according to some embodiments of the present disclosure.

### DETAILED DESCRIPTION

Embodiments of the present disclosure are described by referring to the accompanying drawings. The description is merely illustrative and does not limit the scope of the present disclosure. In addition, descriptions of well-known structures and techniques are omitted to avoid unnecessarily obscuring the concepts of the present disclosure.

Terms used in the present specification are merely for describing specific embodiments, but do not intent to limit the present disclosure. The terms of “including,” “containing,” etc., indicate existences of features, operations, and/or components, but do not exclude existences or additions of one or more other features, operations, or components.

All terms used herein (including technical and science terms) have the meaning commonly understood by those skilled in the art, unless otherwise defined. The terms used here should be interpreted as having a meaning consistent with the context of this specification and should not be interpreted ideally or overly stereotypically.

The accompanying drawings show some block diagrams and/or flowcharts. Some blocks or combinations of the blocks of the block diagrams and/or flowcharts can be implemented by computer program instructions. The computer program instructions can be provided to a general-purpose computer, a special purpose computer, or a processor of another programmable data processing device. As such, these instructions can be executed by the processor to create a device for implementing functions/operations described in these block diagrams and/or flowcharts.

Thus, the techniques of the present disclosure may be implemented in the form of hardware and/or software (including firmware, microcode, etc.). In addition, the techniques of the present disclosure may be in a form of a computer program product on a computer-readable medium that stores instructions. The computer program product can be used by or in connection with an instruction execution system. In the context of the present disclosure, a computer-readable medium may be any medium that can contain, store, communicate, propagate, or transport the instructions. For example, the computer-readable medium may include, but is not limited to, an electronic, magnetic, optical, electromagnetic, infrared or semiconductor system, apparatus, device, or propagation medium. Further, examples of the computer-readable medium include: a magnetic storage device such as a magnetic tape or a hard disk (HDD); an optical storage device such as a compact disk read-only memory (CD-ROM); a memory such as a random-access memory (RAM) or a flash memory; and/or a wired/wireless communication link.

Embodiments of the present disclosure provide a processing method for improving the diversity of automatic replies. The processing method can be applied to a first electronic device. The processing method includes, in response to receiving the communication information sent by the second electronic device, if the first electronic device is in the first state, obtaining the sensor data of the first electronic device. Based on the sensor data, the first state information representing a current behavior state of the user can be determined. Subsequently, the target reply information including the first state information can be generated and sent to a second electronic device. In some embodiments, the first state may indicate that the first electronic device has not responded to the communication information. By generating automatic reply information based on sensor data representing the user's current state, different automatic reply content can be obtained based on different user states, thereby increasing the diversity of users'automatic reply content for missed messages.

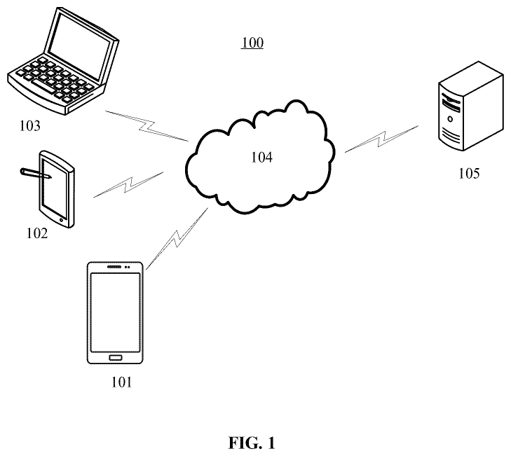

FIG. 1 is an example application scenario of a processing method according to some embodiments of the present disclosure.

As shown in FIG. 1, the application scenario 100 includes terminal devices 101, 102, and 103, a network 104 and a server 105. The network 104 is used to provide a medium for communication links between the terminal devices 101, 102, and 103 and the server 105. The network 104 may include various connection types, such as wired or wireless communication links or fiber optic cables.

Users can use the terminal devices 101, 102, and 103 to interact with the server 105 through the network 104 to receive or send messages, etc., and realize communication between the terminal devices 101, 102, and 103. Various communication client applications can be installed on the terminal devices 101, 102, and 103, such as security applications, shopping applications, web browser applications, search applications, instant messaging tools, email clients, social platform software, etc.

The terminal devices 101, 102, and 103 may be various electronic devices with display screens and support web browsing, including but not limited to smart phones, tablet computers, laptop computers, and desktop computers.

The server 105 may be a server that provides various services, such as a background management server that provides support for websites browsed or applications logged in by users using the terminal devices 101, 102, and 103. The backend management server can analyze and process the received user requests and other data, and feed back the processing results (such as web pages, information, or data obtained or generated based on user requests) to the terminal device to provide personalized automatic reply services for communications between multiple users'terminal devices.

It should be noted that the processing method provided in the embodiments of the present disclosure can generally be executed by the server 105 or by the terminal device. Therefore, the processing device provided in the embodiments of the present disclosure can generally be set in the server 105. The processing method provided in the embodiments of the present disclosure may also be executed by a server or server cluster that is different from the server 105 and that is capable of communicating with the terminal devices 101, 102, and 103 and/or the server 105. Therefore, the processing device provided in the embodiments of the present disclosure may also be set in a server or server cluster that is different from the server 105 and can communicate with the terminal devices 101, 102, and 103 and/or the server 105.

It should be understood that the number of terminal devices, networks, and servers shown in FIG. 1 1 is merely an example and any number of terminal devices, networks, and servers may be provided as needed.

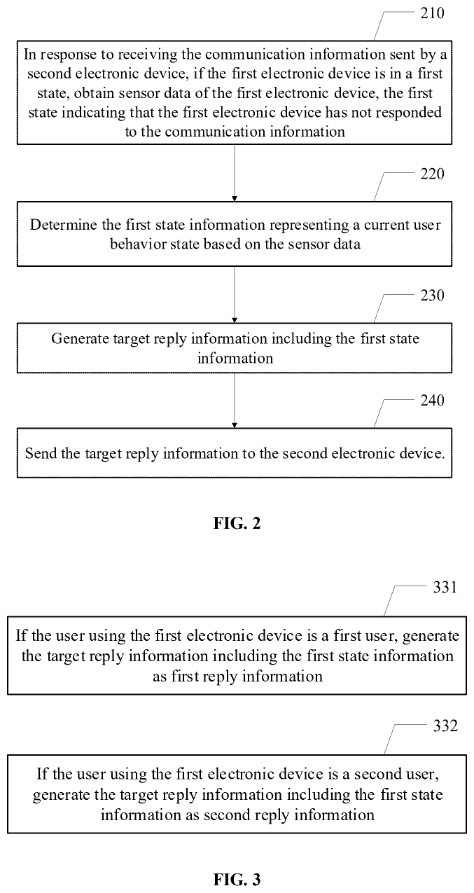

Based on the scenario described in FIG. 1, the processing method will be described in detail below with reference to FIG. 2 to FIG. 8.

FIG. 2 is a flowchart of the processing method according to some embodiments of the present disclosure. The processing method can be applied to a first electronic device. The method will be described in detail below.

210, in response to receiving the communication information sent by a second electronic device, if the first electronic device is in a first state, obtaining sensor data of the first electronic device, the first state indicating that the first electronic device has not responded to the communication information.

The first electronic device will respond to the communication information received from the second electronic device. This is the trigger point of the entire processing flow, which means that when the first electronic device receives the communication information, the subsequent processing steps will be activated.

After receiving the communication information, whether the first electronic device is currently in a first state can be determined. The first state may indicate a state in which the first electronic device has not responded to the communication information.

For example, the communication information sent by the second electronic device may be an incoming call, a text message or a message from other instant messaging tools, etc., and the second electronic device has not received a reply to the communication information from the first electronic device within a preset period of time.

In this case, if the first electronic device is indeed in the first state (i.e., the un-reply state), then the sensor data of the first electronic device can be obtained. The sensor data may include but are not limited to location information, motion state, environmental noise, etc. The embodiments of the present disclosure do not limit the type of sensor data, which can depend on the sensor configuration of the device, and can be set based on actual needs.

220, determining the first state information representing a current user behavior state based on the sensor data.

Based on the obtained sensor data, analysis and processing can be performed to determine the first state information representing the current behavior state of the user.

For example, analyzing location and motion state data may determine whether the user is moving or in a specific location; analyzing environmental noise data may determine whether the user is in a noisy environment and may not be able to respond in time.

230, generating target reply information including the first state information.

After determining the user's current behavior state, target reply information including the first state information can be generated. This information is intended to convey the user's current state to the second electronic device such that the second electronic device can understand why the user did not respond to the communication message in a timely manner.

For example, if the user is currently in a noisy environment and there is no reply within the preset period of time, a message of “The owner's surroundings is noisy and may not have noticed the relevant notification” can be automatically generated.

In another example, if the user is exercising and does not reply within the preset period of time, a message of “Hello, the owner of the device is exercising and cannot reply to the message in time” can be automatically generated.

240, sending the target reply information to the second electronic device.

The first electronic device can send the generated target reply information including the information representing the current behavior state of the user to the second electronic device. In this way, the second electronic device can understand the user's state based on the received information.

Consistent with the present disclosure, by using the sensor data of the first electronic device to infer the user's current behavior state, and generating and sending the target reply information including the state information to the second electronic device, a personalized reply based on the user's current state can be realized.

FIG. 3 is a flowchart of a method of generating the target reply information according to some embodiments of the present disclosure.

As shown in FIG. 3, in addition to the processes of 210 to 240 described above with reference to FIG. 2, the processing method of the present disclosure can further generate the target reply information including the first state information. For the sake of brevity, the description of the processes 210 to 240 will not be repeated here. In addition, in the subsequent related method embodiments, the description of the processes 210 to 240 will also not be repeated.

331, if the user using the first electronic device is a first user, generating the target reply information including the first state information as first reply information.

332, if the user using the first electronic device is a second user, generating the target reply information including the first state information as second reply information.

Different users may respond differently to the same message. For example, when driving, some users are used to replying text messages, while others are used to replying messages including emoticons. In another example, when exercising, some users are used to replying with a specific exercise name, such as lifting weights, while some users are used to replying with a general message, such as exercising.

Therefore, in some embodiments, based on the user's historical reply data, a model can be trained to generate automatic reply content. For the same sensor data, the automatic reply content of different users'devices may or may not be the same.

If a model is used to classify sensor data and a response is generated based on the classification results, different responses can be generated even if the classification results of the sensor data are the same. For example, based on different modes of exercise, although the results obtained from sensor data classification are that the user is moving or exercising, the automatic reply content of the devices used by different users may be different, such as “I am exercising”, “I am practicing yoga”, “I am practicing Tai Chi”, etc.

For devices shared by multiple people, the content of the device's automatic reply may also be determined based on the determination of the current user.

For example, on smart devices, personalized automatic replies can be provided based on the user's different identities (such as family members, work partners) and the current state to enhance the user experience.

More specifically, different users can be distinguished based on the account logged into the smart device, and personalized automatic replies can be provided based on the account logged into the smart device and the sensor data collected by the smart device.

In addition to considering the device state and sensor data, the automatic reply content generated in this embodiment can also be combined with the user identity to achieve a more personalized and flexible communication experience.

FIG. 4 is a flowchart of a method of determining first state information according to some embodiments of the present disclosure.

As shown in FIG. 4, the first state information representing the current user behavior state can be determined based on the sensor data, such as through the process at 421.

421, inputting the sensor data into a target intelligent engine to obtain the first state information representing the current user behavior state.

In some embodiments, if the device is in an unresponsive state, the sensor data of the first electronic device can be obtained. The sensor data of the first electronic device may include location information, motion state, environmental noise, biometric information, etc.

The obtained sensor data can be fed into a pre-trained target intelligence engine (such as a machine learning model, deep learning network, or artificial intelligence algorithm). The intelligent engine can analyze and infer the current user behavior state or situation based on the input sensor data.

The intelligent engine can output the first state information representing the current user behavior state. This may be one or more labels, categories, or probability distributions that describe the user's current behavior, emotions, environment, etc.

Based on the obtained first state information, the target reply information including the state information can be generated. The content of the reply information can be customized based on the specific content of the state information and a preset reply template.

For example, in a smart home system, an intelligent engine can analyze sensor data (such as human activity monitoring, ambient temperature and humidity, etc.) and automatically generate a reply message that matches the user's current state, such as “I'm cooking in the kitchen and will reply to your message later.”

It should be noted that the target intelligent engine may need to be trained and optimized through a large amount of historical sensor data and user behavior data to improve its accuracy and generalization ability. During the training process, supervised learning, unsupervised learning, or semi-supervised learning methods can be used to select the appropriate algorithms and models based on specific business needs and data characteristics.

In this embodiment, an intelligent engine can be used to process and analyze sensor data to better accurately determine the current user behavior state and generate intelligent and personalized automatic reply information.

The target intelligent engine can be used to determine the state information corresponding to the sensor data in a target state information set. The target state information set may include at least two pieces of state information, and the first state information may belong to the target state information set.

In some embodiments, the target intelligent engine may be a classification model for classifying reasons for non-reply. Take missed calls as an example, the classification model for classifying reasons for non-reply may classify missed calls into various reasons for missed calls.

If the device triggers a missed call event, the sensor data of the first electronic device can be obtained. The sensor data may include location information (GPS), acceleration data (used to detect motion state), ambient noise level, microphone activity state (to detect whether there are other calls or voice activities), screen state (whether it is lit), etc.

The obtained sensor data can be fed into a pre-trained classification model for classifying reasons for missed calls. This model can be an example of a target intelligence engine specifically designed to analyze and classify possible reasons for missed calls.

The classification model for classifying the reasons for non-reply can output one or more possible reasons for the missed call based on the input sensor data as first state information representing the current user behavior state. These reasons may include but are not limited to: the user is driving, the user is in a meeting, the user's phone is muted/vibrated but not noticed, the user is in a noisy environment and cannot answer the call, etc.

Based on the determined missed call reasons (i.e., the first status information), the target reply information including the reason information can be generated. The content of the reply information can be customized based on preset reply templates to suit different communication scenarios and user needs.

The generated target reply information (including the reason for the missed call) can be sent to the second electronic device (such as the caller's mobile phone) to realize the automatic reply function and provide an explanation for the reason for the missed call.

It should be noted that the missed call analysis model needs to be trained with a large amount of historical sensor data and the corresponding missed call events to learn the association between different sensor data and missed call reasons. During the training process, supervised learning methods can be used to label the actual reasons for missed calls for each training sample to guide the model training process.

In order to improve the accuracy and generalization ability of the model, technical means such as data enhancement, regularization, and ensemble learning can also be used for optimization.

Consistent with the present disclosure, a specific target intelligent engine, the missed call reason generation model, can be used to process and analyze sensor data, thereby more accurately determining the reasons why users missed calls to generate more intelligent and personalized automatic reply messages.

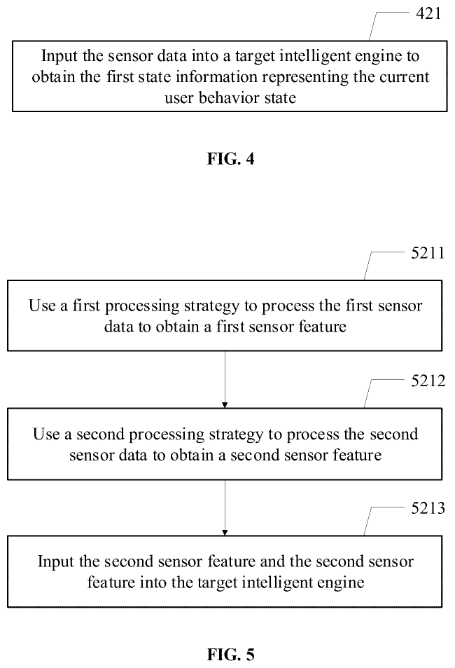

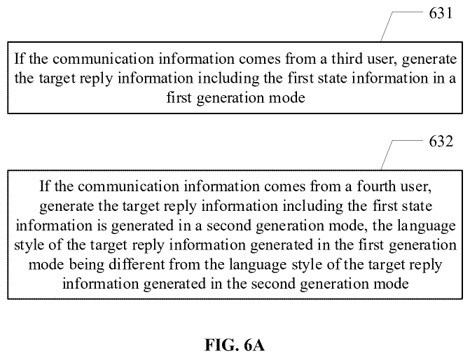

FIG. 5 is a flowchart of the method of determining the first state information according to some embodiments of the present disclosure.

In some embodiments, the sensor data may include first sensor data and second sensor data. As shown in FIG. 5, as an example, the sensor data is input into the target intelligent engine to determine the first state information through the processes of 5211 to 5213.

5211, using a first processing strategy to process the first sensor data to obtain a first sensor feature.

5212, using a second processing strategy to process the second sensor data to obtain a second sensor feature.

5213, inputting the second sensor feature and the second sensor feature into the target intelligent engine.

In some embodiments, the first electronic device may include multiple sensors, such as a gyroscope, an infrared sensor, an acceleration and gravity sensor (i.e., an A+G sensor), etc. These sensors can provide different types of sensor data.

When a first electronic device (e.g., a smartphone) receives a communication message (such as an incoming call) from a second electronic device and does not answer the call, the system can determine whether the device is in an active state and is ready to receive sensor data.

In some embodiments, the system may simultaneously collect data from multiple sensor sources including gyroscopes, infrared sensors, and A+G sensors.

Gyroscope data can reflect the device's rotation state, infrared sensor data can reflect the objects or temperature in the device's surrounding environment, and the A+G sensor data can provide information of the device's acceleration and gravity direction.

For the gyroscope data, the system can apply specific signal processing algorithms (such as filtering and denoising) to extract the device's rotation characteristics, such as the angular velocity and the rotation direction, as the first sensor feature.

For infrared sensor data, the system can apply image processing algorithms (such as edge detection and object recognition) to extract environmental features, such as the number of surrounding objects and the temperature distribution, as the second sensor feature.

For A+G sensor data, the system can apply motion analysis algorithms (such as gait recognition and activity classification) to extract motion features, such as walking, running, and standing still, as the third sensor feature.

Since different sensor data have different dimensions and feature representations, the system needs to map these features into the same dimensional space such that these data can be input into the target intelligent engine for subsequent processing.

In some embodiments, the system may apply one or more feature mapping technologies (such as principal component analysis (PCA), linear discriminant analysis (LDA), neural network, etc.) to map the first sensor feature, the second sensor feature, the third sensor feature, etc. to the same feature space to form a unified feature vector. The unified feature vector includes information from different sensors and can more comprehensively reflect the user's current behavior and situation.

The mapped feature vector is input into the target intelligent engine (such as the missed call reason generation model), and the model performs prediction and classification based on the input feature vector. Then, the model outputs the most likely reason of the missed call as the first state information, which is obtained based on the comprehensive analysis of multi-source sensor data. Subsequently, based on the first state information and the preference information in the user's historical behavior, the system generates a personalized reply message and sends it to the second electronic device to realize the intelligent automatic reply function.

In some embodiments, the system may also collect user feedback on automatic replies, including satisfaction, accuracy of reply content, etc. Based on the user feedback, the system can continuously optimize the algorithm of the target intelligent engine and the multi-sensor data processing strategy to improve the accuracy of automatic replies and user satisfaction.

Consistent with the present disclosure, by introducing multiple sensor data and advanced feature mapping technology, the system can more comprehensively capture the user's current behavior and context, thereby providing users with a more intelligent and personalized service experience.

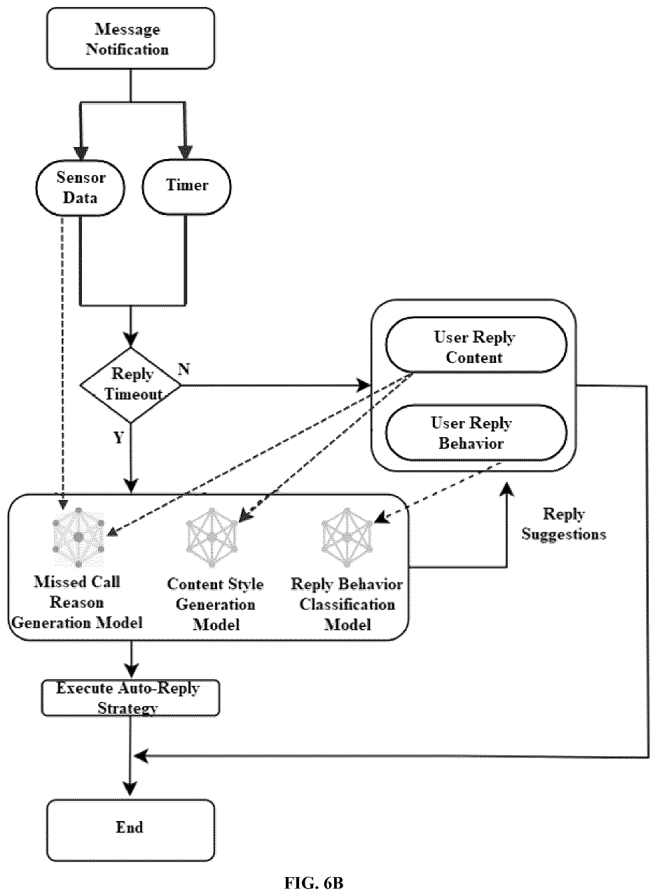

FIG. 6A is a flowchart of the method of generating the target reply information according to some embodiments of the present disclosure, and FIG. 6B is a logic flowchart of the processing method according to some embodiments of the present disclosure.

As shown in FIG. 6A, as an example, the target reply information including the first state information is generated through the processes of 631 to 632.

631, if the communication information comes from a third user, generating the target reply information including the first state information in a first generation mode.

632, if the communication information comes from a fourth user, generating the target reply information including the first state information is generated in a second generation mode, the language style of the target reply information generated in the first generation mode being different from the language style of the target reply information generated in the second generation mode.

In some embodiments, as shown in FIG. 6B, the target intelligent engine includes a missed call reason generation model, a content style generation model, and a reply behavior classification model.

In some embodiments, the system can collect and store users'personal information, historical behavior data, and interaction records with other users for subsequent user-specific analysis.

In some embodiments, when the first electronic device (such as a smartphone) receives a communication message (such as an incoming call) from the second electronic device and does not answer the call, the system may trigger the acquisition of sensor data and caller information in the notification phase and starts the timer. The timeouts can be determined based on strategies such as the timer, missed notification event, phone unlock state, or sensor.

The system can identify the source of the communication information, that is, determine whether the communication information comes from the third user or the fourth user. Then, based on the user's historical behavior data and interaction records, the relationship between the user and the third user and the fourth user, such as the degree of intimacy, business relationship, etc. can be analyzed.

In some embodiments, the system may collect and analyze sensor data (such as location, acceleration, microphone activity, etc.), combine it with user historical behavior data, and apply the missed call cause generation model in the target intelligent engine to determine the possible reasons why the user did not answer the call, that is, the first state information.

If the communication information comes from a third user (which may be the user's friend or close contact), the system may select the first generation mode, which emphasizes the intimacy, informality and personalization of the language.

If the communication information comes from a fourth user (which may be the user's colleague, client or business partner), the system may select the second generation mode, which emphasizes formality, professionalism and politeness of the language.

In some embodiments, the system may input the notification duration, the first state information and user-specific information (such as the relationship between the user and the communication information source) into the trained missed call reason generation model, the content style generation model, and the reply behavior classification mode in the target intelligent engine. Subsequently, the system may infer the strategy of automatic reply, including whether to automatically execute the reply, whether to give reply suggestions, whether to explain the reason for the missed call, reply tone and content generation, etc., and apply the strategy to complete the automatic reply processing process.

In some embodiments, the content style generation model may generate the target reply information that meets user specificity and content style requirements based on the input information and the preset style template.

For example, the first generation mode may generate a reply similar to “Hi, [third user name], I was driving and missed the call, I will get back to you later˜”, while the second generation mode may generate a response similar to “Dear [fourth user name], I am very sorry for not answering your call in time. I am currently dealing with urgent matters and expect to respond to your message after [specific time].”

Subsequently, the system can send the generated target reply information to the second electronic device (i.e. the source device of the communication information) to realize the intelligent automatic reply function.

In addition, for the reply behavior classification model, the system may also determine whether to automatically execute a reply based on the user's historical reply actions, such as immediate reply, delayed reply, and no reply. When the reply is not automatically executed, the system may also generate reply suggestions for the user based on the processing results of the target intelligent engine and display the reply suggestions to the user when the user opens the unprocessed message.

It should be noted that the system may also use the sensor data of this round and the content of the user's reply to incrementally train the reasons for missed calls that may need to be provided in the automatic reply. Using the user's reply content of the current round, the tone and main content of the automatic reply can be incrementally trained. In addition, using the caller information, timing information and the user's method of handling missed notifications, the strategy of replying to the notification can also be incrementally trained.

Consistent with the present disclosure, by introducing user-specific analysis and advanced content style generation technology, the system can automatically adjust the reply style based on different contacts, thereby providing users with a more intelligent and personalized service experience.

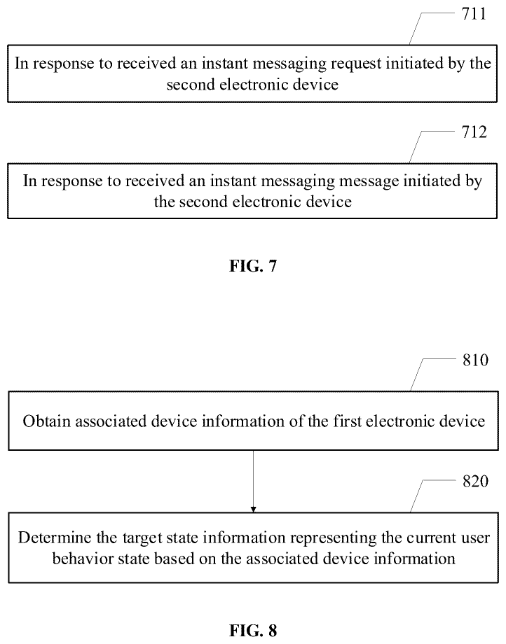

FIG. 7 is a flowchart of a method of responding to received communication information according to some embodiments of the present disclosure.

As shown in FIG. 7, as an example, response to the received communication information sent by the second electronic device is realized through the processes of 711 to 712.

711, in response to receiving an instant messaging request initiated by the second electronic device.

712, in response to receiving an instant messaging message initiated by the second electronic device.

In some embodiments, when the first electronic device is in an inactive state (such as locked, muted, in a call, etc.), the system can receive instant messaging requests from the second electronic device, including audio and video call requests, video chat requests, etc. In this case, the system may identify the type of instant messaging request and checks the current state of the first electronic device, such as whether it is in a state where it can receive calls, whether the do not disturb mode has been set, etc.

If the first electronic device is in an unavailable state, the system may apply the missed call analysis model in the target intelligent engine, combine the sensor data (such as location, acceleration, microphone activity, etc.) and the user historical behavior data to analyze the possible reasons why the user did not answer the instant messaging request.

Then, based on the analysis results, the system may generate a target reply information including the first status information. This can be a simple text message informing the other party of the user's current state (such as “I'm driving, will reply later” or “I'm in a meeting, can't answer”).

Subsequently, the system may send the target reply information to the second electronic device, and record the unanswered instant messaging request and the reason for it for subsequent analysis.

In another example, when the first electronic device is in any state, the system may receive instant messaging messages from the second electronic device, including text messages, picture messages, voice messages, etc. In this case, the system may identify the type and content of the instant messaging messages and determine whether an automatic reply needs to be generated based on the user's historical behavior data and the preference information.

If the system determines that an automatic reply needs to be generated, it will apply the content generation model in the target intelligent engine, combine user-specific information (such as the relationship between the user and the user of the second electronic device, the user's historical reply style, etc.) and the content of the instant messaging message to generate personalized target reply information. In addition, the system may send the target reply information to the second electronic device and record the instant messaging message and its reply for subsequent analysis.

For example, the system may also record all received communication information (including instant messaging requests and instant messaging messages), generated reply information, and user feedback, and regularly analyze this data to identify user behavior patterns, changes in preferences, and possible system improvements.

Consistent with the present disclosure, by introducing the processing logic of instant messaging requests and the automatic reply function of instant messaging messages, the system can provide users with more comprehensive and intelligent communication information processing services.

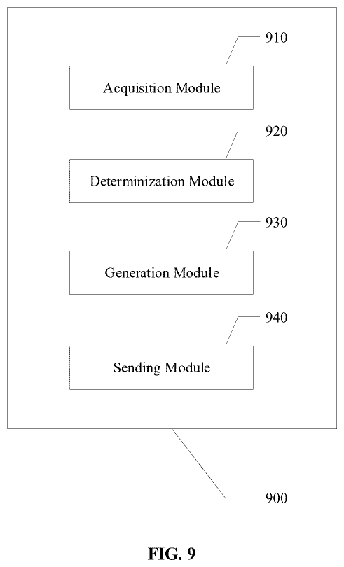

FIG. 8 is a flowchart of the processing method according to some embodiments of the present disclosure.

In some embodiments, before generating the target response information, when determining the target state information based on the sensor data, the current user behavior state may be determined as a non-detectable behavior state, and the processing method may further include processes 810 to 820.

810, obtaining associated device information of the first electronic device.

820, determining the target state information representing the current user behavior state based on the associated device information.

In some embodiments, the first electronic device may be configured with access permissions to other associated devices (such as smart home devices, smart wearable devices, etc.).

When the first electronic device receives communication information (such as an incoming call, an instant messaging message, etc.) from the second electronic device and does not answer the call, the system may prepare to generate a reply message.

The system may first attempt to infer the user's current behavioral state through sensor data of the first electronic device (such as position, acceleration, microphone activity, etc.). If the sensor data is insufficient to determine the specific behavior of the user, that is, the user's current behavior state is a non-detectable behavior state, the system can proceed to the next processing step.

For example, the system may access information of other devices associated with the first electronic device, which may include smart home devices (such as smart door locks, smart lighting, smart appliances, etc.) and smart wearable devices (such as smart watches, smart bracelets, etc.). The system can collect state information of these devices, such as the switch state of smart door locks, the brightness of smart lighting, heart rate monitoring of smart bracelets, etc., to assist in inferring the current user behavior state. In addition, the system can apply the algorithm model in the target intelligent engine and combine it with the information of the associated devices to conduct a comprehensive analysis of the current user behavior state.

For example, if a smart door lock is on and smart lighting is off, and a smart bracelet shows that the user is moving, the system may infer that the user is going out or doing activities outdoors.

Based on the inference results, the system can generate the target state information that represents the current user behavior state.

The system may input the target state information and user-specific information (such as the relationship between the user and the user of the second electronic device, the user's historical reply style, etc.) into the content generation model in the target intelligent engine. The content generation model can generate the target response information that meets user-specific and content style requirements based on the input information and the preset response template. Then, the system can send the generated target reply information to the second electronic device to realize the intelligent automatic reply function.

Consistent with the present disclosure, by introducing the concept of device interconnection, the system can provide users with more accurate and personalized missed call processing services.

Based on the processing method described above, an embodiment of the present disclosure also provides a processing device, which will be described in detail below in conjunction with FIG. 9.

FIG. 9 is a schematic structural diagram of a processing device 900 according to some embodiments of the present disclosure. The processing device can be applied to a first electronic device. As shown in FIG. 9, the processing device 900 includes an acquisition module 910, a determination module 920, a generation module 930, and a sending module 940. The processing device 900 can execute the processing method described above with reference to FIG. 2 to FIG. 8 to implement personalized automatic reply to the second electronic device.

More specifically, the acquisition module 910 may be configured to, in response to receiving the communication information sent by the second electronic device, obtain the sensor data of the first electronic device if the first electronic device is in the first state. In some embodiments, the acquisition module 910 may be configured to perform the process at 210 described above, which will not be repeated here.

The determination module 920 may be configured to determine the first state information representing the current user behavior state based on the sensor data. In some embodiments, the determination module 920 may be configured to perform the process at 220 described above, which will not be repeated here.

The generation module 930 may be configured to generate the target reply information including the first state information. In some embodiments, the generation module 930 may be configured to perform the process at 230 described above, which will not be repeated here.

The sending module 940 may be configured to send the target reply information to the second electronic device. The first state may indicate that the first electronic device has not responded to the communication information. In some embodiments, the sending module 940 may be configured to perform the process at 240 described above, which will not be repeated here.

It should be understood that the acquisition module 910, the determination module 920, the generation module 930, and the sending module 940 can be combined into one module, or any one of the modules can be split into multiple modules. Alternatively, at least some functions of one or more of these modules may be combined with at least some functions of other modules and implemented in one module. According to an embodiment of the present disclosure, at least one of the acquisition module 910, the determination module 920, the generation module 930, and the sending module 940 may be at least partially implemented as a hardware circuit, such as a field programmable gate array (FPGA), a programmable logic array (PLA), a system-on-chip, a system-on-substrate, a system-on-package, an application specific integrated circuit (ASIC), or implemented by hardware or firmware that integrates or packages the circuit in any other reasonable way, or implemented by any one of the three implementations of software, hardware and firmware or by an appropriate combination of any of them. Alternatively, at least one of the acquisition module 910, the determination module 920, the generation module 930, and the sending module 940 may be at least partially implemented as a computer program module which, when executed by a computer, can perform functions of the corresponding module.

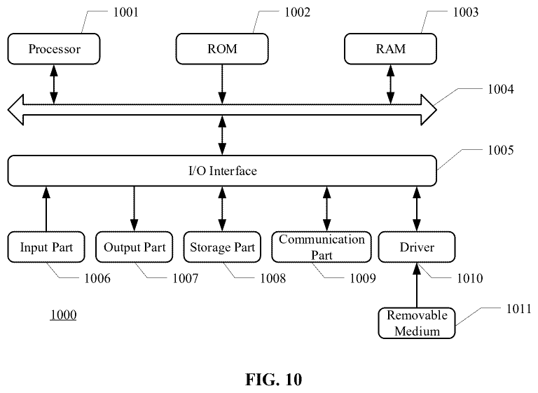

FIG. 10 is a block diagram of a first electronic device suitable for implementing the processing method according to some embodiments of the present disclosure.

As shown in FIG. 10, the first electronic device 1000 described in this embodiment includes a processor 1601 that can perform various appropriate actions and processes according to a program stored in a read-only memory (ROM) 1602 or a program loaded into a random-access memory (RAM) 1603 from a storage part 1608. The processor 1601 may include, for example, a general-purpose microprocessor (such as a CPU), an instruction set processor and/or a related chipset and/or a special-purpose microprocessor (such as an application-specific integrated circuit (ASIC)), etc. The processor 1601 may further include an on-board memory for caching purposes. The processor 1601 may include a single processing unit or a plurality of processing units for performing different actions of a method flow according to the embodiments of the present disclosure.

For example, the processor 1001 can be one or more. The one or more processors can be configured to, in response to receiving a communication message sent by the second electronic device, determine the first state information representing the current behavior state of the user based on the sensor data, generate target reply information including the first state information, and send the target reply information to the second electronic device.

In the RAM 1003, various programs and data required for the operation of the first electronic device 1000 are stored. A processor 1001, a ROM 1002 and a RAM 1003 are connected to each other through a bus 1004. The processor 1601 performs various operations of the method flow according to the embodiments of the present disclosure by executing programs in the ROM 1002 and/or the RAM 1003. It should be noted that the program may also be stored in one or more memories other than the ROM 1002 and the RAM 1003. The processor 1001 may also perform various operations of the method flow based on the embodiments of the present disclosure by executing programs stored in one or more memories.

As shown in FIG. 10, the first electronic device 1000 also includes an input/output (I/O) interface 1005, which is also connected to the bus 1004. The system 1000 may further include one or more of the following components connected to the I/O interface 1005: an input part 1006 such as a keyboard, a mouse, etc.; an output part 1007 such as a cathode ray tube (CRT), a liquid crystal display (LCD), a speaker, etc.; a storage part 1608 such as a hard disk, etc.; and a communication part 1009 such as a network interface card such as a LAN card, a modem, etc. The communication part 1009 performs communication processing via a network such as the Internet. The driver 1010 is also connected to the I/O interface 1005 as needed. A removable medium 1011, such as a magnetic disk, an optical disk, a magneto-optical disk, a semiconductor memory, etc., is installed on the driver 1010 as needed, so that a computer program read therefrom can be installed into the storage part 1008 as needed.

For example, the input part 1006 may also include one or more sensors for obtaining sensor data based on the state of the first electronic device. In some embodiments, a first state may indicate that the first electronic device has not responded to the communication information.

An embodiment of the present disclosure further provides a computer-readable storage medium, which may be included in the device/apparatus/system described in the above embodiments, and may also exist separately without being assembled into the device/apparatus/system. The computer-readable storage medium carries one or more programs, and when the one or more programs are executed, the processing method provided in the embodiments of the present disclosure is implemented.

According to an embodiment of the present disclosure, the computer-readable storage medium may be a nonvolatile computer-readable storage medium, which may include, for example, but not limited to: a portable computer disk, a hard disk, a random access memory (RAM), a read-only memory (ROM), an erasable programmable read-only memory (EPROM or flash memory), a portable compact disk read-only memory (CD-ROM), an optical storage device, a magnetic storage device, or any suitable combination of the above. In an embodiment of the present disclosure, a computer-readable storage medium may be any tangible medium containing or storing a program, and the program may be used by or used in combination with an instruction execution system, apparatus or device. For example, according to an embodiment of the present disclosure, a computer-readable storage medium may include the ROM 1002 and/or the RAM 1003 described above, and/or one or more memories other than the ROM 1002 and the RAM 1003.

An embodiment of the present disclosure further includes a computer program product, which includes a computer program containing program codes for performing the method shown in the flowchart. The program codes are configured for, when the computer program product is run in a computer system, causing the computer system to implement the processing method provided in the embodiments of the present disclosure.

When the computer program is executed by the processor 1001, the above functions defined in the system/apparatus of the embodiments of the present disclosure are performed. According to an embodiment of the present disclosure, the system, apparatus, module, unit, etc. described above may be implemented by a computer program module.

In an embodiment, the computer program may rely on a tangible storage medium such as an optical storage device and a magnetic storage device. In another embodiment, the computer program may also be transmitted and distributed in the form of signals on a network medium and downloaded and installed through the communication part 1009, and/or installed from the removable medium 1011. The program codes contained in the computer program may be transmitted by any suitable network medium, including but not limited to: a wireless network medium, a wired network medium, etc., or any suitable combination of the above.

In such an embodiment, the computer program may be downloaded and installed from the network through the communication part 1009 and/or installed from the removable medium 1011. When the computer program is executed by the processor 1001, the above functions defined in the system embodiments of the present disclosure are performed. According to an embodiment of the present disclosure, the system, device, apparatus, module, unit, etc. described above may be implemented by a computer program module.

According to an embodiment of the present disclosure, program codes for executing the computer program provided by the embodiments of the present disclosure may be written in any combination of one or more programming languages, and specifically, these computer programs may be implemented by using high-level procedural and/or object-oriented programming languages and/or assembly/machine languages. The programming languages include but are not limited to Java, C++, python, “C” or similar programming languages. The program code may be executed entirely on the user computing device, executed partially on the user device, executed as a stand-alone package, executed partially on the remote computing device, or executed entirely on the remote computing device or the server. In the case involving the remote computing device, the remote computing device may be connected to the user computing device via any kind of network, including a local area network (LAN) or a wide area network (WAN), or, alternatively, may be connected to an external computing device (e.g., using an Internet service provider to connect via the Internet).

The flowchart and block diagrams in the accompanying drawings illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It will be understood by those skilled in the art that the features described in the respective embodiments and/or claims of the present disclosure may be combined in various ways, even if such combinations are not explicitly described in the present disclosure. In particular, without departing from the spirit and teaching of the present disclosure, the features described in the respective embodiments and/or claims can be combined in various ways. All of these combinations fall within the scope of the present disclosure.

The embodiments of the present disclosure have been described above. However, these embodiments are for illustrative purposes only, and are not intended to limit the scope of the present disclosure. Although the embodiments have been described separately above, this does not mean that measures in the respective embodiments cannot be used in combination advantageously. The scope of the present disclosure is defined by the appended claims and their equivalents. Without departing from the scope of the present disclosure, those skilled in the art may make various substitutions and modifications, and these substitutions and modifications should all fall within the scope of the present disclosure.

What is claimed is:

1. A processing method, applied to a first electronic device, comprising:
in response to receiving communication information sent by a second electronic device, if the first electronic device is in a first state, obtaining sensor data of the first electronic device;
determining first state information representing a current user behavior state based on the sensor data;
generating target reply information including the first state information; and
sending the target reply information to the second electronic device, wherein:
the first state indicates that the first electronic device has not responded to the communication information.

2. The method of claim 1, wherein generating the target reply information including the first state information includes:
in response to the user using the first electronic device being a first user, generating the target reply information including the first state information as first reply information; and
in response to the user using the first electronic device being a second user, generating the target reply information including the first state information as second reply information.

3. The method of claim 1, wherein determining the first state information representing the current user behavior state based on the sensor data includes:
inputting the sensor data into a target intelligent engine to obtain the first state information representing the current user behavior state.

4. The method of claim 3, wherein:
the target intelligent engine is used to determine state information corresponding to the sensor data in a target state information set, the target state information set includes at least two pieces of state information, and the first state information belongs to the target state information set.

5. The method of claim 3, wherein:
the sensor data includes first sensor data and second sensor data; and
inputting the sensor data into the target intelligent engine includes:
using a first processing strategy to process the first sensor data to obtain a first sensor feature;
using a second processing strategy to process the second sensor data obtain a second sensor feature; and
sending the first sensor feature and the second sensor feature into the target intelligent engine.

6. The method of claim 1, wherein generating the target reply information including the first state information includes:
in response to the communication information coming from a third user, generating the target reply information including the first state information in a first generation mode; and
in response to the communication information coming from a fourth user, generating the target reply information including the first state information in a second generation mode, wherein:
a language style of the target reply information generated by the first generation mode is different from the language style of the target reply information generated by the second generation mode.

7. The method of claim 1, wherein, in response to receiving the communication information sent by the second electronic device, includes:
in response to receiving an instant messaging request initiated by the second electronic device; or,
in response to receiving the instant messaging message initiated by the second electronic device.

8. The method of claim 1, wherein before generating the target reply information, if the current user behavior state is a non-detectable behavior state when determining the target state information based on the sensor data, the method further includes:
obtaining associated device information of the first electronic device; and
determining the target state information representing the current user behavior state based on the associated device information.

9. A computer readable storage medium storing computer instructions, when executed by one or more processors, the computer instructions perform a processing method, the method comprising:
in response to receiving communication information sent by a second electronic device, if the first electronic device is in a first state, obtaining sensor data of the first electronic device;
determining first state information representing a current user behavior state based on the sensor data;
generating target reply information including the first state information; and
sending the target reply information to the second electronic device, wherein:
the first state indicates that the first electronic device has not responded to the communication information.

10. The computer readable storage medium of claim 9, wherein generating the target reply information including the first state information includes:
in response to the user using the first electronic device being a first user, generating the target reply information including the first state information as first reply information; and
in response to the user using the first electronic device being a second user, generating the target reply information including the first state information as second reply information.

11. The computer readable storage medium of claim 9, wherein determining the first state information representing the current user behavior state based on the sensor data includes:
inputting the sensor data into a target intelligent engine to obtain the first state information representing the current user behavior state.

12. The computer readable storage medium of claim 11, wherein:
the target intelligent engine is used to determine state information corresponding to the sensor data in a target state information set, the target state information set includes at least two pieces of state information, and the first state information belongs to the target state information set.

13. The computer readable storage medium of claim 11, wherein:
the sensor data includes first sensor data and second sensor data; and
inputting the sensor data into the target intelligent engine includes:
using a first processing strategy to process the first sensor data to obtain a first sensor feature;
using a second processing strategy to process the second sensor data obtain a second sensor feature; and
sending the first sensor feature and the second sensor feature into the target intelligent engine.

14. The computer readable storage medium of claim 11, wherein generating the target reply information including the first state information includes:
in response to the communication information coming from a third user, generating the target reply information including the first state information in a first generation mode; and
in response to the communication information coming from a fourth user, generating the target reply information including the first state information in a second generation mode, wherein:
a language style of the target reply information generated by the first generation mode is different from the language style of the target reply information generated by the second generation mode.

15. The computer readable storage medium of claim 9, wherein, in response to receiving the communication information sent by the second electronic device, includes:
in response to receiving an instant messaging request initiated by the second electronic device; or,
in response to receiving the instant messaging message initiated by the second electronic device.

16. The computer readable storage medium of claim 9, wherein before generating the target reply information, if the current user behavior state is a non-detectable behavior state when determining the target state information based on the sensor data, the method further includes:
obtaining associated device information of the first electronic device; and
determining the target state information representing the current user behavior state based on the associated device information.

17. A first electronic device comprising:
one or more sensors, the one or more sensors being configured to obtain sensor data based on a state of the first electronic device; and
one or more processors, the one or more processors being configured to, in response to receiving communication information sent by a second electronic device, determine first state information representing a current user behavior state based on the sensor data, generate target reply information including the first state information, and send the target reply information to the second electronic device, wherein:
the first state indicates that the first electronic device has not responded to the communication information.

18. The electronic device of claim 17, wherein the one or more processors are further configured to:
in response to the user using the first electronic device being a first user, generate the target reply information including the first state information as first reply information; and
in response to the user using the first electronic device being a second user, generate the target reply information including the first state information as second reply information.

19. The electronic device of claim 17, wherein the one or more processors are further configured to:
input the sensor data into a target intelligent engine to obtain the first state information representing the current user behavior state.

20. The electronic device of claim 19, wherein:
the target intelligent engine is used to determine state information corresponding to the sensor data in a target state information set, the target state information set includes at least two pieces of state information, and the first state information belongs to the target state information set.
